(19) United States
(12) Patent Application Publication
(10) Pub. No.: US 2020/0011183 A1
(43) Pub. Date: Jan. 9, 2020

(54) ROTOR OF A FLUID FLOW MACHINE

(71) Applicant: ROLLS-ROYCE DEUTSCHLAND LTD & CO KG, Blankenfelde-Mahlow (DE)

(72) Inventor: Ingolf BEHR, Potsdam (DE)

(21) Appl. No.: 16/459,196

(22) Filed: Jul. 1, 2019

(30) Foreign Application Priority Data
Jul. 6, 2018 (DE) 10 2018 116 391.6

(51) Int. Cl. F01D 5/02; G01M 1/36

(52) U.S. Cl. CPC F01D 5/027; G01M 1/36; F05D 2260/96; F05D 2240/24; F05D 2220/3212

(57) ABSTRACT

A turbomachine rotor includes a hub and rotor blades. An imbalance correction device is provided which extends radially inside the hub bottom and includes axially front and rear walls, together with the hub bottom, defining a volume of the imbalance correction device. A mass piece, during normal operation of the rotor, is arranged on the axis of rotation. A filler material at least partially fills the volume and surrounds the mass piece in a radial direction. Radial bores extend in a radial direction from the hub bottom side through the rotor hub to a respectively assigned rotor blade. The radial bores and the filler material are formed and coordinated such that, upon loss of a rotor blade, filler material escapes from the thus exposed radial bore assigned to the lost rotor blade, wherein the mass piece moves on the axis of rotation toward the lost rotor blade.

This application claims priority to German Patent Application DE102018116391.6 filed Jul. 6, 2018, the entirety of which is incorporated by reference herein.

The invention relates to a rotor of a turbomachine as per the preamble of patent Claim 1.

The loss of a fan blade of an engine, for example as a result of a bird strike or material fatigue, leads to extreme loads in the form of a large imbalance in the engine, which lead to intense vibrations in the engine and determine the entire design of the structural components of the engine. It is therefore sought to minimize the loads that arise in the event of a loss of a fan blade.

It is correspondingly also the case for other rotors that it is sought to minimize the imbalances, and associated loads, that arise in the event of a loss of a rotor blade or in the event of a blade breakage.

DE 102010032985 B4 has disclosed a balancing device for reducing an imbalance of a body rotating about an axis of rotation, which body has a shaft, a housing connected rotationally conjointly to the shaft, and a balancing mass in the form of a liquid quantity, wherein at least three chambers for receiving the liquid quantity are arranged in the housing, and the liquid quantity is adjustable during the rotation.

The invention is based on the object of providing a rotor of a turbomachine in the case of which the imbalances that arise as a result of the loss of a rotor blade are reduced.

This object is achieved by a rotor having the features of patent Claim 1. Design embodiments of the invention are set forth in the dependent claims.

Accordingly, the invention relates to a rotor of a turbomachine, which rotor comprises a rotor hub, which has a hub top side and a hub bottom side, and a multiplicity of rotor blades, which project from the hub top side. The rotor has an axis of rotation. The rotor is for example a fan or a rotor of a compressor stage or of a turbine stage.

According to the present invention, an imbalance correction device is provided which extends radially inside the hub bottom side and which is delimited radially to the outside by said hub bottom side. The imbalance correction device has an axially front wall and an axially rear wall, which, together with the hub bottom side, define a volume of the imbalance correction device. Said volume is typically cylindrical or approximately cylindrical, wherein other volume shapes are however also possible in a manner dependent on the shaping of the hub bottom side.

The imbalance correction device furthermore comprises a mass piece which, during normal operation of the rotor, is arranged on the axis of rotation. Here, normal operation refers to operation during which all of the blades of the rotor are present. As a further component, the imbalance correction device comprises a filler material which at least partially fills the volume and, in so doing, surrounds the mass piece in a radial direction. This has the effect that the mass piece remains centered on the axis of rotation of the rotor during normal operation.

The rotor according to the invention comprises radial bores which extend in a radial direction from the hub bottom side through the rotor hub to a respectively assigned rotor blade, wherein each radial bore is closed off at its radially outer end by the associated rotor blade. Here, the radial bores may likewise be filled with the filler material.

The radial bores and the filler material are formed and coordinated with one another such that, in the event of a loss of a rotor blade, filler material escapes from the thus exposed radial bore assigned to the lost rotor blade, wherein the mass piece moves from its position on the axis of rotation in the direction of the lost rotor blade.

The invention is thus based on the concept of reducing or even compensating an imbalance that arises in the event of a loss of a rotor blade by virtue of a mass piece arranged on the axis of rotation of the rotor being pushed outward below the missing rotor blade owing to the centrifugal force. This is achieved in that, after breakage of a rotor blade, the radial bore assigned to the rotor blade opens, such that the filler material escapes from the imbalance correction device through the radial bore, with the result that the mass piece follows the filler material escaping from the radial bore in the direction of the lost rotor blade or in the direction of the assigned radial bore.

As mentioned, the imbalance correction device has an axially front wall and an axially rear wall, which, together with the hub bottom side, define a volume of the imbalance correction device. Here, the expression “volume” is to be understood to mean that a certain spatial region is provided, in which the imbalance correction device is formed. This volume of the imbalance correction device is filled with components of the imbalance correction device. These are firstly the mass piece and secondly the filler material, which surrounds the mass piece in a radial direction. As further components, the imbalance correction device may, as will be discussed, have structural components such as internal wall elements and radially extending structures, which for example define tracks for the mass piece and/or valve flaps. Here, the filler material is situated in all cavities of the imbalance correction device, wherein a cavity is a space, which would be hollow without the filler material, within the volume under consideration. In fact, owing to the filler material, the entire volume in which the imbalance correction device is formed, is filled with material.

As already mentioned, provision is made for the filler material to surround the mass piece in the radial direction. This has the effect that the mass piece remains centered on the axis of rotation of the rotor during normal operation. Further measures may be implemented in order to realize such centering during normal operation. For example, provision may be made whereby the mass piece, in the rest position, is additionally mounted on an axle which has a predetermined breaking point. This may be expedient in particular if the surrounding filler material is not sufficient to ensure adequate mounting of the mass piece. In the event of an imbalance, the predetermined breaking point breaks.

In one design embodiment of the invention, the balance correction device forms a multiplicity of tracks for the mass piece. The tracks extend from the axis of rotation, or from the space which accommodates the mass piece, radially outward to the hub bottom side. Here, said tracks adjoin at least one radial bore. The tracks are filled with the filler material. In the event of the loss of a rotor blade, the filler material escapes from the track that adjoins the bore of the missing rotor blade. Accordingly, the mass piece is forced by the centrifugal force into the track from which the filler material escapes.

It is however firstly pointed out that the formation of predefined tracks for the mass piece in the imbalance correction device is not imperative. Even without the formation of a track, the mass piece is automatically forced in the direction from which the filler material escapes from the imbalance correction device. Through the provision of defined tracks, this effect can however be intensified, in particular if filler material of other tracks is prevented from being able to ingress into the track that is presently affected.

Secondly, it is pointed out that the number of tracks does not need to be identical to the number of rotor blades or to the number of radial bores in the rotor hub. Rather, design embodiments of the invention provide for the number of tracks to be smaller than the number of rotor blades. For example, provision may be made for a track to end at for example 2-5 radial bores, or to be connected to such a number of radial bores. In this way, the accuracy with which the mass piece is moved exactly under the lost rotor blade is duly reduced. However, the mass piece can be formed with a greater volume and thus with a greater mass, because the tracks can have a larger diameter.

The tracks are defined for example by radially running structures which are spaced apart in a circumferential direction. Here, provision may be made whereby the radially running structures extend from the hub bottom side in the direction of the axis of rotation. Provision may also be made whereby radially running structures arranged adjacently in a circumferential direction have different radial extents.

In terms of production, the tracks may be formed into the imbalance correction device in a variety of ways. In a first design variant, the structures that define the tracks are connected firstly to one wall and subsequently to the other wall of the imbalance correction device. In the second design variant, a solid plate is provided which has a defined thickness. In said plate, a central region for receiving the mass piece, and the tracks, are then milled into the base material of the plate. The rear side of said plate forms a wall of the imbalance correction device. The other wall of the imbalance correction device is mounted onto the plate machined in this way.

The tracks may also be referred to as channels or transport channels.

A further design embodiment of the invention provides for the imbalance correction device to have valve flaps which divide the volume of the imbalance correction device into different regions, wherein the valve flaps are each formed so as to prevent filler material of a region from being able to escape from the region in question counter to the radial direction. This prevents filler material that is escaping through an opened radial bore from being replaced by filler material of other regions, which would reduce a movement of the mass piece in the direction of the lost rotor blade.

According to one design embodiment of the invention, valve flaps are provided in combination with tracks which are formed in the balance correction device. Here, the valve flaps are arranged such that, in the event of loss of a rotor blade, all of the tracks close aside from the track that adjoins the radial bore through which filler material escapes after loss of the rotor blade. By contrast, the valve flap of the track from which filler material escapes opens, because the filler material passes said valve flap in a radial direction, in which situation the valve flap opens.

Here, provision may be made in particular whereby each track is assigned at least one valve flap.

The valve flaps are formed for example by two inner walls which extend substantially in a circumferential direction and, in so doing, are arranged at an angle with respect to one another. Provision may furthermore be made whereby the imbalance correction device has multiple, for example two, concentric arrangements of inner walls with valve flaps. In this way, it is achieved in an effective manner that filler material cannot flow into a track from regions which do not belong to the affected track.

The mass piece may basically have any desired shape. Design embodiments provide for the mass piece to be of rotationally symmetrical form with respect to the circumferential direction. In particular, provision may be made whereby the mass piece is of cylindrical form or formed as a ball. The cylindrical form has the advantage here that an extremely large partial volume in the imbalance correction device is provided for the arrangement of the mass piece.

In one design embodiment of the invention, the mass piece is composed of a solid body, for example a metal, wherein design embodiments provide for a heavy metal such as for example tungsten to be used. It may naturally be advantageous for a material of high density to be used for the mass piece, such that an imbalance associated with the loss of a rotor blade can be compensated as effectively as possible. In other design embodiments, the mass piece is composed not of a solid body but of a liquid, wherein, in design embodiments, said liquid may be surrounded by a deformable protective sleeve which prevents the liquid from propagating into the filler material. It is also possible for the mass piece to be formed from other deformable materials.

In one design embodiment of the invention, the filler material is composed of a flowable powder or bulk material. Here, this may have been compressed in the imbalance correction device. In one exemplary embodiment, for this purpose, the filler material is formed by glass beads, for example by glass beads with a mean grain size in the range between 0.01 mm and 0.1 mm, in particular in the range between 0.04 mm and 0.06 mm.

According to an alternative embodiment, the filler material is formed by a liquid or a gas. Such an embodiment is associated with the advantage that the filler material can escape quickly and effectively from a radial bore after a loss of a rotor blade. However, such an effective escape can also be ensured in the case of a powder or bulk material, wherein parameters such as the flowability of the filler material and the diameter of the radial bore must be set correspondingly.

A further design embodiment of the invention provides for the radial bores which extend in the hub from the hub bottom side to the hub top side not to end at the hub top side, and thus in the root region of the rotor blades, but rather to also extend over a defined radial length within the respective rotor blades, and end for example at 50% of the radial height of the rotor blades. This design embodiment is associated with the advantage that, even in the event that a rotor blade does not break away completely, but rather the breaking point is situated at a radial distance from the hub top side, the radial bore is opened up and, as a result of the escape of filler material, a displacement of the mass piece, which counteracts the imbalance that arises, can be initiated. Here, provision may also be made whereby the radial bore ends, at its radially outer end, in a cavity formed in the rotor blade. Rotor blades equipped with one or more cavities are used for example in fan blades, in some embodiments, for mass reduction.

It is pointed out that the rotor according to the invention may have a multiplicity of imbalance correction devices with respectively associated radial bores. Here, the multiplicity of imbalance correction devices is formed one behind the other in an axial direction in the rotor.

For this purpose, one design embodiment provides for the radial bores which are respectively assigned to an imbalance correction device and which interact with the latter in the described manner to extend into the rotor blades in a radial direction to different extents in each imbalance correction device. Furthermore, provision may be made here whereby an imbalance correction device in which the assigned radial bores extend further (that is to say with a greater radial length) into the rotor blades is equipped with a correspondingly more lightweight mass piece (that is to say a mass piece which is smaller or of lower density). This is associated with the advantage that, if a rotor blade breaks away further to the outside, then an imbalance correction device with a more lightweight mass piece is activated, and accordingly a more lightweight mass piece is forced outward in this situation. An imbalance correction can thus be realized in a manner dependent on how much mass is lost in the event of the breakage of the rotor blade.

As already stated, the rotor according to the invention may basically be any rotor of a turbomachine. One design embodiment of the invention provides for the rotor to be a fan, and for the rotor blades to be fan blades. In the event of the loss or breakage of a fan blade, the problem arises, to a particularly high degree, that high loads are introduced into the engine owing to the imbalance that arises. By means of the solution according to the invention, the imbalance, and thus the level of vibrations, in the engine can be considerably reduced. Since the loads that arise are reduced, weight can be saved in the component design of the structural components of the engine.

A further design embodiment provides for the rotor blades and the rotor hub to be formed as a single piece. For this purpose, provision may be made for the rotor to be of BLISK design, in which case a rotor disk, the rotor hub and the rotor blades are formed integrally (as a single piece) (BLISK=“Blade Integrated Disk”), or for the rotor to be of BLING design, in which case the rotor hub and the rotor blades are formed integrally (as a single piece) (BLING=“Blade Integrated Ring”), wherein, in the context of this description, both of these variants are referred to as “BLISK design”. It is however pointed out that, in other exemplary embodiments, the rotor blades may be formed in the conventional manner with a blade root, which blade roots are arranged in corresponding recesses of the rotor hub.

In this context, it is pointed out that the rotor according to the invention may have a rotor disk, in which case the imbalance correction device is arranged at an axial distance from a rotor disk of said type. Other design embodiments, in particular if the rotor is in the form of a fan, provide for a rotor disk not to be provided per se, and for the rotor to have, for example, a flange for the connection to a drive shaft.

In a further aspect of the invention, the invention relates to a gas turbine engine, in particular for an aircraft, having a rotor according to the invention. Provision may be made here whereby the gas turbine engine has:
an engine core which comprises a turbine, a compressor and a core shaft connecting the turbine to the compressor and formed as a hollow shaft;
a fan which is positioned upstream of the engine core, wherein the fan comprises a plurality of fan blades and is designed according to the invention; and
a gearbox that receives an input from the turbine shaft and outputs drive to the fan so as to drive the fan at a lower rotational speed than the turbine shaft.

One design embodiment to this end can provide that
the turbine is a first turbine, the compressor is a first compressor, and the turbine shaft is a first turbine shaft;
the engine core further comprises a second turbine, a second compressor, and a second turbine shaft which connects the second turbine to the second compressor; and
the second turbine, the second compressor, and the second turbine shaft are arranged so as to rotate at a higher rotational speed than the first turbine shaft.

It is pointed out that the present invention, to the extent that the latter relates to an aircraft gas turbine, is described with reference to a cylindrical coordinate system which has the coordinates x, r, and φ. Here, x indicates the axial direction, r indicates the radial direction, and φ indicates the angle in the circumferential direction. The axial direction is in this case identical to a machine axis of a gas turbine engine in which the rotor is arranged. Proceeding from the x-axis, the radial direction points radially outward. Terms such as “in front of”, “behind”, “front”, and “rear” refer to the axial direction, or the flow direction in the engine. Terms such as “outer” or “inner” refer to the radial direction.

As noted elsewhere herein, the present disclosure can relate to a gas turbine engine. Such a gas turbine engine may comprise an engine core which comprises a turbine, a combustion chamber, a compressor, and a core shaft that connects the turbine to the compressor. Such a gas turbine engine can comprise a fan (having fan blades) which is positioned upstream of the engine core.

Arrangements of the present disclosure can be particularly, although not exclusively, beneficial for fans that are driven via a gearbox. Accordingly, the gas turbine engine can comprise a gearbox that receives an input from the core shaft and outputs drive to the fan so as to drive the fan at a lower rotational speed than the core shaft. The input to the gearbox can be performed directly from the core shaft or indirectly from the core shaft, for example via a spur shaft and/or a spur gear. The core shaft can be rigidly connected to the turbine and the compressor, such that the turbine and the compressor rotate at the same rotational speed (wherein the fan rotates at a lower rotational speed).

The gas turbine engine as described and/or claimed herein can have any suitable general architecture. For example, the gas turbine engine can have any desired number of shafts, for example one, two or three shafts, that connect turbines and compressors. Purely by way of example, the turbine connected to the core shaft can be a first turbine, the compressor connected to the core shaft can be a first compressor, and the core shaft can be a first core shaft. The engine core can further comprise a second turbine, a second compressor, and a second core shaft which connects the second turbine to the second compressor. The second turbine, the second compressor, and the second core shaft can be arranged so as to rotate at a higher rotational speed than the first core shaft.

In such an arrangement, the second compressor can be positioned so as to be axially downstream of the first compressor. The second compressor can be arranged so as to receive (for example directly receive, for example via a generally annular channel) flow from the first compressor.

The gearbox can be arranged so as to be driven by the core shaft (for example the first core shaft in the example above) which is configured to rotate (for example when in use) at the lowest rotational speed. For example, the gearbox can be arranged so as to be driven only by the core shaft (for example only by the first core shaft, and not the second core shaft, in the example above) that is configured to rotate (for example when in use) at the lowest rotational speed. Alternatively thereto, the gearbox can be arranged so as to be driven by one or a plurality of shafts, for example the first and/or the second shaft in the example above.

In the case of a gas turbine engine as described and/or claimed herein, a combustion chamber can be provided axially downstream of the fan and of the compressor(s). For example, the combustion chamber can lie directly downstream of the second compressor (for example at the exit of the latter), when a second compressor is provided. By way of further example, the flow at the exit of the compressor can be provided to the inlet of the second turbine, when a second turbine is provided. The combustion chamber can be provided so as to be upstream of the turbine(s).

The or each compressor (for example the first compressor and the second compressor as described above) can comprise any number of stages, for example multiple stages. Each stage can comprise a row of rotor blades and a row of stator blades, which may be variable stator blades (in the sense that the angle of incidence of said variable stator blades can be variable). The row of rotor blades and the row of stator blades can be axially offset from each other.

The or each turbine (for example the first turbine and the second turbine as described above) can comprise any number of stages, for example multiple stages. Each stage can comprise a row of rotor blades and a row of stator blades. The row of rotor blades and the row of stator blades can be axially offset from each other.

Each fan blade can be defined as having a radial span extending from a root (or a hub) at a radially inner location flowed over by gas, or at a 0% span width position, to a tip at a 100% span width position. The ratio of the radius of the fan blade at the hub to the radius of the fan blade at the tip can be less than (or in the region of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip can be in an inclusive range delimited by two of the values in the previous sentence (that is to say that the values can form upper or lower limits). These ratios can commonly be referred to as the hub-to-tip ratio. The radius at the hub and the radius at the tip can both be measured at the leading periphery (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centerline and the tip of the fan blade at the leading periphery of the latter. The diameter of the fan (which may simply be double the radius of the fan) can be larger than (or in the region of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter can be in an inclusive range delimited by two of the values in the previous sentence (that is to say that the values can form upper or lower limits).

The rotational speed of the fan can vary when in use. Generally, the rotational speed is lower for fans with a comparatively large diameter. Purely by way of non-limiting example, the rotational speed of the fan at constant speed conditions can be less than 2500 rpm, for example less than 2300 rpm. Purely by way of further non-limiting example, the rotational speed of the fan at constant speed conditions for an engine having a fan diameter in the range from 250 cm to 300 cm (for example 250 cm to 280 cm) can also be in the range from 1700 rpm to 2500 rpm, for example in the range from 1800 rpm to 2300 rpm, for example in the range from 1900 rpm to 2100 rpm. Purely by way of further non-limiting example, the rotational speed of the fan at constant speed conditions for an engine having a fan diameter in the range from 320 cm to 380 cm can be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a speed Uₜᵢₚ. The work done by the fan blades on the flow results in an enthalpy rise dH in the flow. A fan tip loading can be defined as dH/Uₜᵢₚ², where dH is the enthalpy rise (for example the 1-D average enthalpy rise) across the fan and Uₜᵢₚ is the (translational) velocity of the fan tip, for example at the leading periphery of the tip (which can be defined as the fan tip radius at the leading periphery multiplied by the angular speed). The fan tip loading at constant speed conditions can be more than (or in the region of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading can be in an inclusive range delimited by two of the values in the previous sentence (that is to say that the values can form upper or lower limits).

Gas turbine engines in accordance with the present disclosure can have any desired bypass ratio, where the bypass ratio is defined as the ratio of the mass flow rate of the flow through the bypass duct to the mass flow rate of the flow through the core at constant speed conditions. In the case of some arrangements, the bypass ratio can be more than (or in the region of): 10, 10.5, 11, 11.5, 12, 12.5, 13, 13.5, 14, 14.5, 15, 15.5, 16, 16.5, or 17. The bypass ratio can be in an inclusive range delimited by two of the values in the previous sentence (that is to say that the values can form upper or lower limits). The bypass duct can be substantially annular. The bypass duct can be situated radially outside the engine core. The radially outer surface of the bypass duct can be defined by an engine nacelle and/or a fan casing.

The overall pressure ratio of a gas turbine engine as described and/or claimed herein can be defined as the ratio of the stagnation pressure upstream of the fan to the stagnation pressure at the exit of the highest pressure compressor (before entry into the combustion chamber). By way of non-limiting example, the overall pressure ratio of a gas turbine engine as described and/or claimed herein at constant speed can be greater than (or in the region of): 35, 40, 45, 50, 55, 60, 65, 70, 75. The overall pressure ratio can be in an inclusive range delimited by two of the values in the previous sentence (that is to say that the values can form upper or lower limits).

The specific thrust of an engine can be defined as the net thrust of the engine divided by the total mass flow through the engine. The specific thrust of an engine as described and/or claimed herein at constant speed conditions can be less than (or in the region of): 110 Nkg⁻¹ s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust can be in an inclusive range delimited by two of the values in the previous sentence (that is to say that the values can form upper or lower limits). Such engines can be particularly efficient in comparison with conventional gas turbine engines.

A gas turbine engine as described and/or claimed herein can have any desired maximum thrust. Purely by way of non-limiting example, a gas turbine as described and/or claimed herein can be capable of generating a maximum thrust of at least (or in the region of): 160 kN, 170 kN, 180 kN, 190 kN, 200 kN, 250 kN, 300 kN, 350 kN, 400 kN, 450 kN, 500 kN, or 550 kN. The maximum thrust can be in an inclusive range delimited by two of the values in the previous sentence (that is to say that the values can form upper or lower limits). The thrust referred to above can be the maximum net thrust at standard atmospheric conditions at sea level plus 15 degrees C. (ambient pressure 101.3 kPa, temperature 30 degrees C.), at a static engine.

In use, the temperature of the flow at the entry to the high pressure turbine can be particularly high. This temperature, which can be referred to as TET, can be measured at the exit to the combustion chamber, for example directly upstream of the first turbine blade, which in turn can be referred to as a nozzle guide blade. At constant speed, the TET can be at least (or in the region of): 1400K, 1450K, 1500K, 1550K, 1600K, or 1650K. The TET at constant speed can be in an inclusive range delimited by two of the values in the previous sentence (that is to say that the values can form upper or lower limits). The maximum TET in the use of the engine can be at least (or in the region of), for example: 1700K, 1750K, 1800K, 1850K, 1900K, 1950K, or 2000K. The maximum TET can be in an inclusive range delimited by two of the values in the previous sentence (that is to say that the values can form upper or lower limits). The maximum TET can occur, for example, at a high thrust condition, for example at a maximum take-off thrust (MTO) condition.

A fan blade and/or an airfoil portion of a fan blade described and/or claimed herein can be manufactured from any suitable material or a combination of materials. For example, at least a part of the fan blade and/or of the airfoil can be manufactured at least in part from a composite, for example a metal matrix composite and/or an organic matrix composite, such as carbon fiber. By way of further example, at least a part of the fan blade and/or of the airfoil can be manufactured at least in part from a metal, such as a titanium-based metal or an aluminum-based material (such as an aluminum-lithium alloy) or a steel-based material. The fan blade can comprise at least two regions which are manufactured using different materials. For example, the fan blade can have a protective leading periphery, which is manufactured using a material that is better able to resist impact (for example of birds, ice, or other material) than the rest of the blade. Such a leading periphery can, for example, be manufactured using titanium or a titanium-based alloy. Thus, purely by way of example, the fan blade can have a carbon-f iber-based or aluminum-based body (such as an aluminum-lithium alloy) with a titanium leading periphery.

A fan as described and/or claimed herein can comprise a central portion, from which the fan blades can extend, for example in a radial direction. The fan blades can be attached to the central portion in any desired manner. For example, each fan blade can comprise a fixing device which can engage with a corresponding slot in the hub (or disk). Purely by way of example, such a fixing device can be in the form of a dovetail that can be inserted into and/or engage with a corresponding slot in the hub/disk in order for the fan blade to be fixed to the hub/disk. By way of further example, the fan blades can be formed integrally with a central portion. Such an arrangement can be referred to as a blisk or a bling. Any suitable method can be used to manufacture such a blisk or bling. For example, at least a part of the fan blades can be machined from a block and/or at least a part of the fan blades can be attached to the hub/disk by welding, such as linear friction welding, for example.

The gas turbine engines described and/or claimed herein may or may not be provided with a variable area nozzle (VAN). Such a variable area nozzle can allow the exit cross section of the bypass duct to be varied when in use. The general principles of the present disclosure can apply to engines with or without a VAN.

The fan of a gas turbine as described and/or claimed herein can have any desired number of fan blades, for example 16, 18, 20, or 22 fan blades.

As used herein, constant speed conditions can mean constant speed conditions of an aircraft to which the gas turbine engine is attached. Such constant speed conditions can be conventionally defined as the conditions at mid-cruise, for example the conditions experienced by the aircraft and/or the engine between (in terms of time and/or distance) the top of climb and the start of descent.

Purely by way of example, the forward speed at the constant speed condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example in the region of Mach 0.8, in the region of Mach 0.85 or in the range of from 0.8 to 0.85. Any arbitrary speed within these ranges can be the constant cruise condition. In the case of some aircraft, the constant cruise conditions can be outside these ranges, for example below Mach 0.7 or above Mach 0.9.

Purely by way of example, the constant speed conditions can correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example in the region of 11,000 m. The constant speed conditions can correspond to standard atmospheric conditions at any given altitude in these ranges.

Purely by way of example, the constant speed conditions can correspond to the following: a forward Mach number of 0.8; a pressure of 23,000 Pa; and a temperature of −55 degrees C.

As used anywhere herein, “constant speed” or “constant speed conditions” can mean the aerodynamic design point. Such an aerodynamic design point (or ADP) can correspond to the conditions (including, for example, the Mach number, environmental conditions, and thrust requirement) for which the fan operation is designed. This can mean, for example, the conditions at which the fan (or the gas turbine engine) has optimum efficiency in terms of construction.

In use, a gas turbine engine described and/or claimed herein can operate at the constant speed conditions defined elsewhere herein. Such constant speed conditions can be determined by the constant speed conditions (for example the mid-cruise conditions) of an aircraft to which at least one (for example 2 or 4) gas turbine engine can be fastened in order to provide the thrust force.

It is self-evident to a person skilled in the art that a feature or parameter described above in relation to one of the above aspects can be applied to any other aspect, unless they are mutually exclusive. Furthermore, any feature or any parameter described here can be applied to any aspect and/or combined with any other feature or parameter described here, unless they are mutually exclusive.

The invention will be explained in more detail hereunder by means of a plurality of exemplary embodiments with reference to the figures of the drawing. In the drawing:

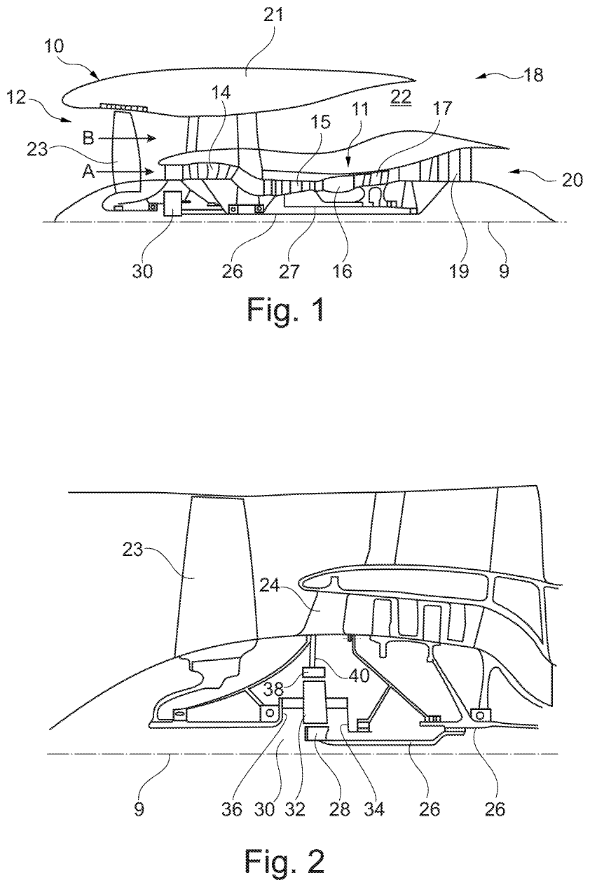

FIG. 1 shows a sectional lateral view of a gas turbine engine;

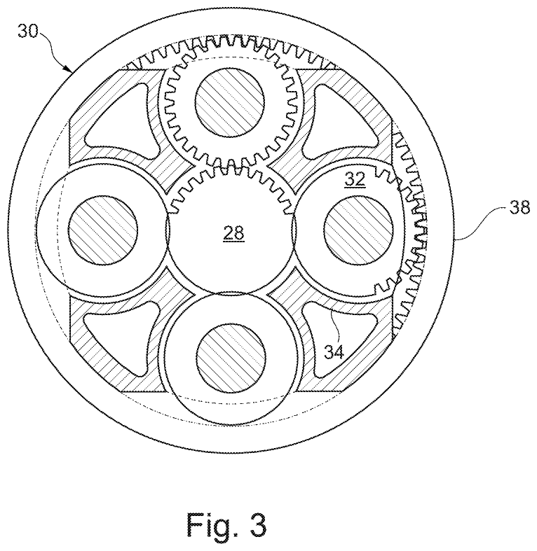

FIG. 2 shows a close-up sectional lateral view of an upstream portion of a gas turbine engine;

FIG. 3 shows a partially cut-away view of a gearbox for a gas turbine engine;

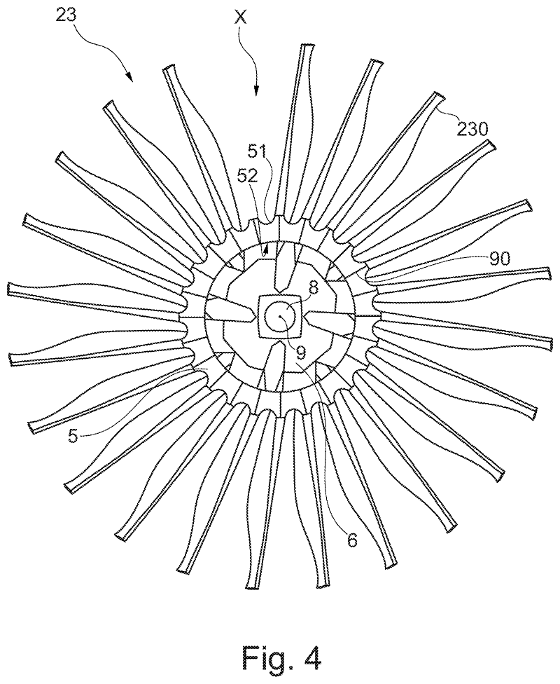

FIG. 4 shows a view from the front of an exemplary embodiment of a fan with a fan hub, fan blades and an imbalance correction device, which is arranged within the fan hub and which has a mass piece which, during normal operation of the fan, is arranged on the axis of rotation;

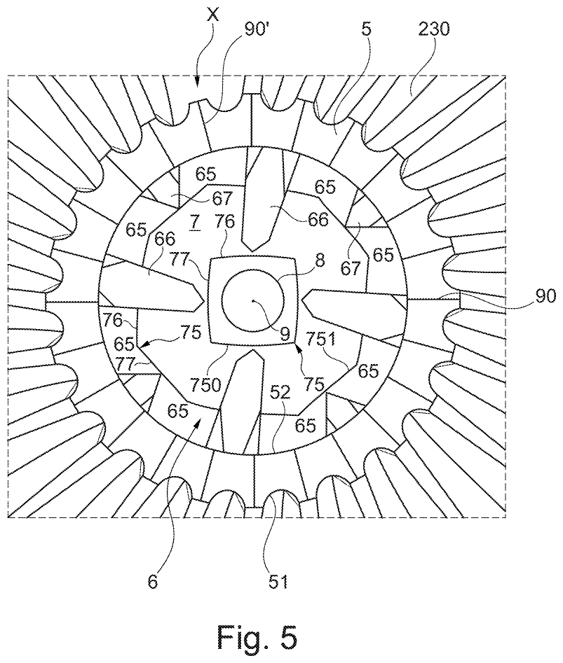

FIG. 5 shows the fan of FIG. 4 with an enlarged illustration of the imbalance correction device;

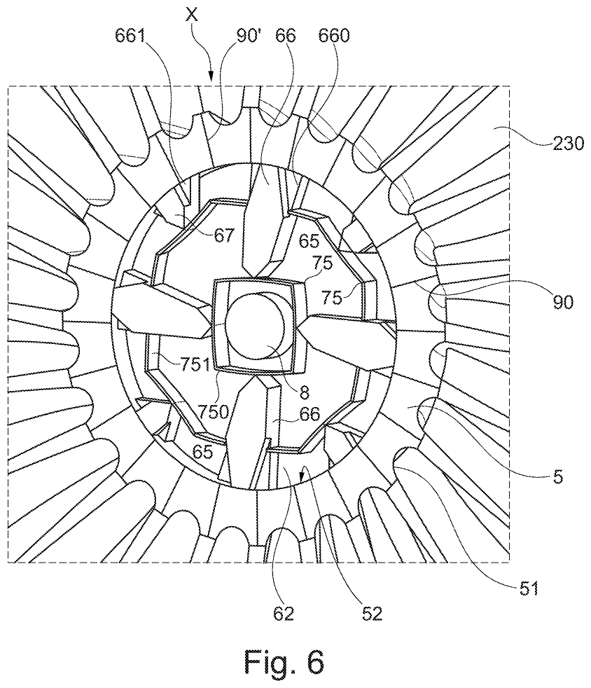

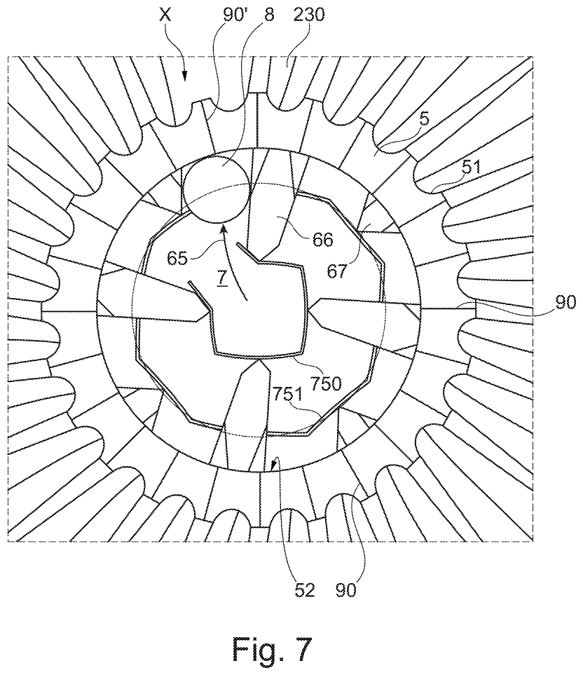

FIG. 6 shows the fan of FIG. 5 with a perspective illustration of the imbalance correction device, wherein

FIG. 7 shows the fan with imbalance correction device of FIG. 5, in the case of which the mass piece has been moved from the axis of rotation in the direction of the position of a lost blade;

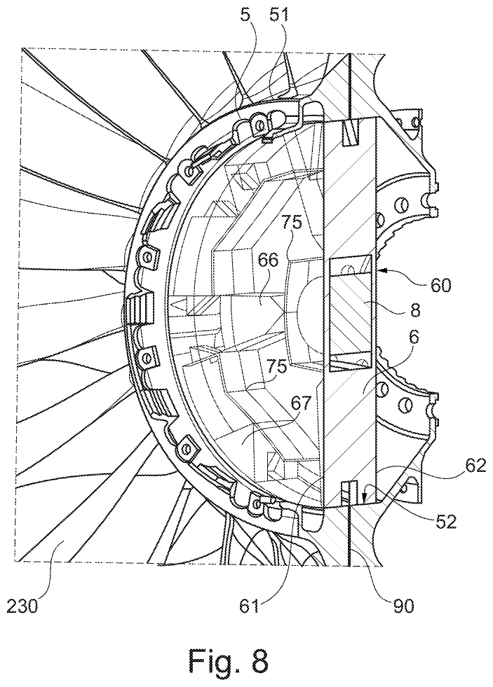

FIG. 8 shows a perspective and in this case transparent sectional view of the imbalance correction device of FIGS. 4-7; and

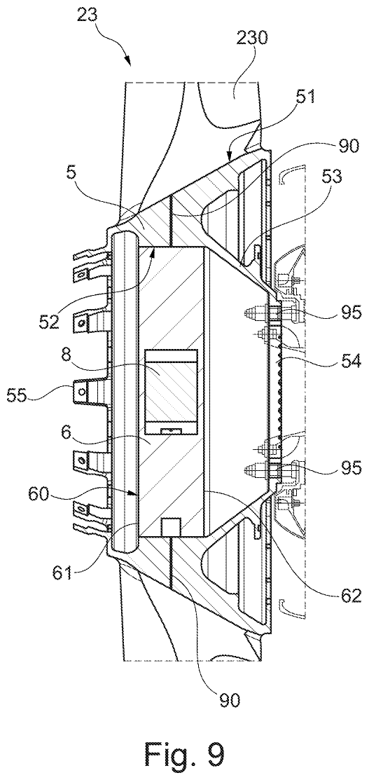

FIG. 9 shows, in axial section, a fan with an imbalance correction device as per FIGS. 4-8.

FIG. 1 represents a gas turbine engine 10 having a main axis of rotation 9. The engine 10 comprises an air intake 12 and a thrust fan 23 that generates two airflows: a core airflow A and a bypass airflow B. The gas turbine engine 10 comprises a core 11 which receives the core airflow A. In the sequence of axial flow, the engine core 11 comprises a low-pressure compressor 14, a high-pressure compressor 15, a combustion installation 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass airflow B flows through the bypass duct 22. The fan 23 is attached to and driven by the low pressure turbine 19 by way of a shaft 26 and an epicyclic gearbox 30.

During use, the core airflow A is accelerated and compressed by the low-pressure compressor 14 and directed into the high-pressure compressor 15, where further compression takes place. The compressed air exhausted from the high-pressure compressor 15 is directed into the combustion device 16, where it is mixed with fuel and the mixture is combusted. The resultant hot combustion products then expand through, and thereby drive, the high-pressure and low-pressure turbines 17, 19 before being exhausted through the nozzle 20 to provide some thrust force. The high-pressure turbine 17 drives the high-pressure compressor 15 by means of a suitable connecting shaft 27. The fan 23 generally provides the majority of the thrust force. The epicyclic gearbox 30 is a reduction gearbox.

An exemplary assembly for a gearbox fan gas turbine engine 10 is shown in FIG. 2. The low-pressure turbine 19 (see FIG. 1) drives the shaft 26, which is coupled to a sun gear 28 of the epicyclic gearbox assembly 30. Radially to the outside of the sun gear 28 and meshing therewith are a plurality of planet gears 32 that are coupled to one another by a planet carrier 34. The planet carrier 34 limits the planet gears 32 to orbiting around the sun gear 28 in a synchronous manner whilst enabling each planet gear 32 to rotate about its own axis. The planet carrier 34 is coupled by way of linkages 36 to the fan 23 so as to drive the rotation of the latter about the engine axis 9. Radially to the outside of the planet gears 32 and meshing therewith is an annulus or ring gear 38 that is coupled, via linkages 40, to a stationary supporting structure 24.

It is noted that the terms “low-pressure turbine” and “low-pressure compressor” as used herein can be taken to mean the lowest pressure turbine stage and the lowest pressure compressor stage (that is to say not including the fan 23) respectively and/or the turbine and compressor stages that are connected to one another by the connecting shaft 26 with the lowest rotational speed in the engine (that is to say not including the gearbox output shaft that drives the fan 23). In some literature, the “low-pressure turbine” and the “low-pressure compressor” referred to herein can alternatively be known as the “intermediate pressure turbine” and “intermediate-pressure compressor”. Where such alternative nomenclature is used, the fan 23 can be referred to as a first compression stage or lowest-pressure compression stage.

The epicyclic gearbox 30 is shown in an exemplary manner in greater detail in FIG. 3. Each of the sun gear 28, the planet gears 32 and the ring gear 38 comprise teeth about their periphery to mesh with the other gears. However, for clarity, only exemplary portions of the teeth are illustrated in FIG. 3. There are four planet gears 32 illustrated, although it will be apparent to the person skilled in the art that more or fewer planet gears 32 can be provided within the scope of protection of the claimed invention. Practical applications of an epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, wherein the ring gear 38 is fixed. However, any other suitable type of epicyclic gearbox 30 can be used. By way of further example, the epicyclic gearbox 30 can be a star arrangement, in which the planet carrier 34 is held so as to be fixed, wherein the ring gear (or annulus) 38 is allowed to rotate. In the case of such an arrangement, the fan 23 is driven by the ring gear 38. By way of further alternative example, the gearbox 30 can be a differential gearbox in which the ring gear 38 and the planet carrier 34 are both allowed to rotate.

It goes without saying that the arrangement shown in FIGS. 2 and 3 is merely an example, and various alternatives fall within the scope of protection of the present disclosure. Purely by way of example, any suitable arrangement can be used for positioning the gearbox 30 in the engine 10 and/or for connecting the gearbox 30 to the engine 10. By way of further example, the connections (such as the linkages 36, 40 in the example of FIG. 2) between the gearbox 30 and other parts of the engine 10 (such as the input shaft 26, the output shaft and the fixed structure 24) can have a certain degree of stiffness or flexibility. By way of further example, any suitable arrangement of the bearings between rotating and stationary parts of the engine (for example between the input and output shafts of the gearbox and the fixed structures, such as the gearbox casing) can be used, and the disclosure is not limited to the exemplary arrangement of FIG. 2. For example, where the gearbox 30 has a star arrangement (described above), the person skilled in the art would readily understand that the arrangement of output and support linkages and bearing positions would typically be different to that shown by way of example in FIG. 2.

Accordingly, the present disclosure extends to a gas turbine engine having an arbitrary arrangement of gearbox types (for example star-shaped or planetary), support structures, input and output shaft arrangement, and bearing positions.

Optionally, the gearbox can drive additional and/or alternative components (e.g. the intermediate pressure compressor and/or a booster compressor).

Other gas turbine engines to which the present disclosure can be applied can have alternative configurations. For example, engines of this type can have an alternative number of compressors and/or turbines and/or an alternative number of connecting shafts. By way of further example, the gas turbine engine shown in FIG. 1 has a split flow nozzle 20, 22, meaning that the flow through the bypass duct 22 has its own nozzle that is separate to and radially outside the core engine nozzle 20. However, this is not limiting, and any aspect of the present disclosure can also apply to engines in which the flow through the bypass duct 22 and the flow through the core 11 are mixed, or combined, before (or upstream of) a single nozzle, which can be referred to as a mixed flow nozzle. One or both nozzles (whether mixed or split flow) can have a fixed or variable area. Whilst the example described relates to a turbofan engine, the disclosure can be applied, for example, to any type of gas turbine engine, such as, for example, an open rotor engine (in which the fan stage is not surrounded by an engine nacelle) or a turboprop engine. In some arrangements, the gas turbine engine 10 may not comprise a gearbox 30.

The geometry of the gas turbine engine 10, and components thereof, is/are defined by a conventional axis system, comprising an axial direction (which is aligned with the rotational axis 9), a radial direction (in the bottom-to-top direction in FIG. 1), and a circumferential direction (perpendicular to the view in FIG. 1). The axial, radial and circumferential directions are mutually perpendicular.

In the context of the invention, what is of significance is a design of the fan 23 such that, in the event of the loss of a fan blade, imbalances associated with this should be minimized. The description of the invention on the basis of a fan 23 is in this case merely exemplary. The principles of the invention apply basically to each rotor.

FIG. 4 firstly gives an overview of the major components of a fan 23 designed according to the invention. The fan 23 comprises a fan hub 5, which has a hub top side 51 and a hub bottom side 52. A multiplicity of fan blades 230 project from the hub top side 51, which fan blades are arranged equidistantly in the circumferential direction and form a blade ring. The hub top side 51 forms a ring surface, and in so doing delimits the flow duct through the fan 23 radially to the inside.

The fan 23 is of BLISK design, such that the fan hub 5 and the fan blades 230 are formed as a single piece. The single-piece form may be provided for example by virtue of the fan hub 5 and fan blades 230 being produced integrally, or by virtue of the fan blades 230 being welded to the fan hub 5. An embodiment of BLISK design is however not imperative. Alternatively, the fan blades 23 may each have a blade root, which is fastened with a corresponding recess in the fan hub 5.

The fan 32 is rotatable about an axis of rotation 9 which runs in the axial direction. This is for example the axis of rotation 9 of FIG. 1.

Within the fan hub 5, that is to say radially inside the hub bottom side 52, the fan 23 has an imbalance correction device 6. Here, said imbalance correction device is delimited radially to the outside by the hub bottom side 52. The imbalance correction device 6 occupies, within the fan hub 5, a particular volume which is defined by its radial extent from the axis of rotation 9 to the hub bottom side 52 and by an axial extent between an axially front wall and an axially rear wall (as will be discussed in more detail with reference to FIG. 8). The volume occupied by the imbalance correction device 6 is in this case cylindrical or approximately cylindrical.

In the center of the imbalance correction device 6, that is to say symmetrically with respect to the axis of rotation 9 in the mass distribution of said imbalance correction device, there is arranged a mass piece 8. As will be discussed on the basis of the following FIGS. 5-9, the imbalance correction device 6 is provided and designed to, in the event of the loss of a fan blade 230, cause the mass piece 8 to be moved from its position on the axis of rotation 9 in the direction of the lost fan blade. In FIG. 4, in which a fan blade has been lost in the region X, the mass piece 8 would thus move in the direction of the region X. This is realized using a filler material, which is arranged in the imbalance correction device 6, and by means of radial bores 90, which are formed in the rotor hub 5.

FIGS. 5-9 show the imbalance correction device 6 in an enlarged illustration, wherein FIG. 5 shows a view from above, FIG. 6 shows a perspective view, FIG. 8 shows a partially sectional perspective and in this case transparent view, and FIG. 9 shows a view in axial section. FIG. 7 illustrates the situation in which, after a loss of a fan blade 230, the mass piece 8 has travelled from its position on the axis of rotation 9 in the direction of the lost fan blade.

Referring firstly to FIGS. 5 and 6, it can be seen that the volume occupied by the imbalance correction device 6 is structured and forms a multiplicity of tracks 65, along which the mass piece 8 can move in the event of the loss of a fan blade 230. The tracks 65 are defined by radially running structures 66, 67 which are spaced apart in a circumferential direction. Here, first radially running structures 66, which extend from the hub bottom side 52 to a relatively great extent in the direction of the axis of rotation 9, and a second radially running structures 67, which extend from the hub bottom side 52 to a lesser extent in the direction of the axis of rotation 9, alternate with one another.

The volume occupied by the imbalance correction device 6 is furthermore structured by means of valve flaps 75, which divide the interior of the imbalance correction device into different regions. Each valve flap 75 is formed by two pivotable inner walls 76, 77 which are arranged obliquely with respect to one another. Here, the valve flaps 75 are oriented such that they only open in the outward radial direction, whereas they close in the inward radial direction.

Here, the inner walls 76, 77 form two substantially concentric arrangements 750, 751 of inner walls, wherein the radially inner concentric arrangement 750 runs approximately in the spacing of the radially inner ends of the first radially running structures 66 and, here, the pivot axes of the inner walls 76, 77 lie against said radially inner ends. The radially outer concentric arrangement 751 runs approximately in the spacing of the radially inner ends of the second radially running structures 67, wherein the pivot axes of the inner walls 76, 77 lie partially against said radially inner ends and partially laterally against the first radially running structures 66.

Here, in the exemplary embodiment illustrated, the radially inner concentric arrangement 750 forms four valve flaps 75, and the radially outer concentric arrangement 751 forms eight valve flaps 75. It is however pointed out that these are to be understood merely as an example. It is alternatively possible for only one concentric arrangement or more than two concentric arrangements, which are each formed valve flaps, to be provided. Design embodiments are also possible which make do without the implementation of valve flaps.

The tracks 65 generated by the structuring of the imbalance correction device 6 end in each case at the hub bottom side 52. Radial bores 90 run in the fan hub 5, which radial bores extend in a radial direction from the hub bottom side 52 to a respectively assigned fan blade 230, wherein each radial bore 90 is closed off at its radially outer end by the associated fan blade 230.

In the perspective illustration of FIG. 6, it can be seen that the structuring, resulting from the radially extending structures 66, 67 and the valve flaps 75 or the substantially concentric arrangements 750, 751 of inner walls, of the imbalance correction device 6 defines numerous cavities of the imbalance correction device 6. Referring to FIG. 8, it is pointed out here that the imbalance correction device 6 forms an axially front wall 61 and an axially rear wall 62, which, together with the hub bottom side 52, define a volume 60 of the imbalance correction device 6. Said volume firstly contains the stated structures 66, 67, 750, 751, and self-evidently the mass piece 8, and secondly has cavities, where the stated structures are not present.

In this context, it is pointed out once again that the design of valve flaps 75 and concentric arrangements 750, 751 of inner walls relate to merely one exemplary embodiment, and are optional for the invention.

All of the cavities of the imbalance correction device 6 are filled with a filler material 7, which is however not illustrated in the perspective illustration of FIG. 6 so as not to conceal the structural elements of the imbalance correction device 6.

The filler material 7 fills in particular all of the raceways 65 for the mass piece 8, and here, surrounds the mass piece 8 in a radial direction. The filler material 7 thus prevents the mass piece 8 from being able to move out of its position on the axis of rotation 9 during the normal operation of the fan.

The filler material 7 is formed by a flowable material. This is, in one exemplary embodiment, a flowable powder or bulk material, for example glass beads with a mean grain size in the range between 0.01 mm and 0.1 mm, in particular in the range between 0.04 mm and 0.06 mm. In another exemplary embodiment, the filler material 7 is a liquid.

In the exemplary embodiment illustrated, the mass piece 8 is of cylindrical form. It is composed for example of a metal, for example of tungsten. In one exemplary embodiment, a cylindrical mass piece 8 formed from tungsten has an axial length in the range between 40 mm and 120 mm and a radial diameter in the range between 50 mm and 100 mm. The mass piece 8 may however basically have a shape which deviates from a cylindrical shape, for example may be formed as a ball.

During the normal operation of the fan 23, that is to say in the case of intact fan blades 230, the radial bores 90 are closed off radially to the outside by the respectively assigned fan blades 230. This state changes if a loss of a fan blade 230 or a blade breakage occurs. In the region X, in which a fan blade is missing after such a loss, the associated radial bore 90′ is then open at its radially outer end. This means that the filler material 7 present in the tracks 65 of the imbalance correction device 6 can escape from the imbalance correction device 6 through said bore 90′. This will also occur owing to the imbalance that arises after a blade loss.

This however means that the massive forces that act on the mass piece 8 owing to the imbalance that arises after the loss of the fan blade can now push said mass piece in the direction of the escaping filler material 7, because the escaping filler material 7 opens up a corresponding volume. Here, the mass piece 8 is automatically pushed into that one of the tracks 65 which ends at the radial bore 90′ from which the filler material is escaping after the loss of the fan blade 230.

In this context, it is pointed out that, in the exemplary embodiment illustrated, each track 65 ends at a multiplicity of radial bores 90, though this is not imperative. Otherwise, the tracks 65 would have to be formed with a small diameter, which in turn would reduce the diameter of the mass piece and thus the mass thereof.

It is also pointed out that it is not the case that the radially running first and second structures 66, 67, in the region in which they adjoin the hub bottom side 52, would close off the radial bores 90 formed there. As can be seen from the perspective illustration of FIG. 6, the first and second radial running structures 66, 67 rather form material recesses 660, 661, by means of which the adjoining radial bores 90 are exposed to the hub bottom side 520, such that filler material can also escape via these bores in the event of the loss of a fan blade 230.

By contrast to the illustration in the figures, provision may be made for the radial bores 90 to extend into the fan blades 230 over a certain radial height, and to end for example in internal cavities that the fan blades 230 may have depending on their type of construction. Such an embodiment is associated with the advantage that, even in the event of an only partial breakaway of a fan blade 230, a radial bore 90 is opened at its radially outer end, and filler material 7 can escape.

A further embodiment provides for several of the imbalance correction devices 6 to be positioned axially one behind the other. Here, the radial bores 90 assigned to the individual imbalance correction devices 6 extend into the blades 230 to different extents. Provision is furthermore made for the individual imbalance correction devices 6 to be equipped with mass pieces 8 of different weight, wherein, in the case of an imbalance correction device in which the assigned radial bores 90 extend into the blades 230 over a relatively great radial length, the mass piece 8 is of correspondingly more lightweight form. If a blade 230 breaks away further to the outside, a more lightweight mass piece 8 is accordingly forced outward.

FIG. 7 shows the situation in which, after loss of a fan blade in the region X, the mass piece 8 has been moved from its position on the axis of rotation 9, along a track 65 in the direction of the lost fan blade, onto the hub bottom side 52. Owing to this displacement of the mass piece 8, the imbalance generated as a result of the loss of the fan blade is considerably reduced.

In the sectional illustration of FIG. 9, it can additionally be seen that the hub 5 receives the imbalance correction device 6 only over a part of the axial length of said hub. This axial length is determined by the axial distance between the front wall 61 and the rear wall 62 of the imbalance correction device 6. In this axial portion, the hub bottom side 52 is, in the exemplary embodiment illustrated but not imperatively, of rectilinear form, such that, in the exemplary embodiment illustrated, the imbalance correction device 6 occupies, overall, a cylindrical volume 60.

In a manner known per se, the hub 5 has further structures. Accordingly, at the axially front end, there are provided fastening means 55 for connection to a nose cone. At the axially rear end, the hub forms a wall region 53, which extends obliquely radially inward and ends in a flange 54, which serves for connecting the fan 23 via fastening means 95 to a drive shaft, for example corresponding with the FIG. 2.

Further alternative design embodiments provided for the hub 8 to furthermore form a rotor disk, which is formed axially in front of or axially behind the imbalance correction device 6. This is the case in particular in situations in which the imbalance correction device is formed not in the hub of a fan but rather in the hub of some other rotor, for example of a rotor of a compressor stator of a turbine stage.

It is pointed out that air holes (not illustrated) may be formed in the axially front wall 61 and/or in the axially rear wall 62, which air holes ensure that, in the event of the breakage of a fan blade, the escape of the filler material 7 is not impaired by a negative pressure in the imbalance correction device 6. Such air holes are for example formed such that filler material cannot pass through them. This may be achieved for example by means of the size of said air holes, and/or valves.

It goes without saying that the invention is not limited to the above-described embodiments, and various modifications and improvements can be made without departing from the concepts described herein. For example, provision may be made whereby the tracks formed in the imbalance correction device for the mass piece are provided in some other form and/or by means of other structures.

It is furthermore pointed out that any of the features described can be used separately or in combination with any other features, unless they are mutually exclusive. The disclosure also extends to and comprises all combinations and sub-combinations of one or a plurality of features which are described here. If ranges are defined, said ranges thus comprise all of the values within said ranges as well as all of the partial ranges that lie in a range.

1. A rotor for a turbomachine, which rotor has:
a rotor hub which has a hub top side and a hub bottom side,
a multiplicity of rotor blades which project from the hub top side,
wherein the rotor has an axis of rotation,
wherein
an imbalance correction device which extends radially inside the hub bottom side and which is delimited radially to the outside by said hub bottom side, wherein the imbalance correction device has:
an axially front wall and an axially rear wall, which, together with the hub bottom side, define a volume of the imbalance correction device,
a mass piece which, during normal operation of the rotor, is arranged on the axis of rotation,
a filler material which at least partially fills the volume and which surrounds the mass piece in a radial direction,
radial bores which extend in a radial direction from the hub bottom side through the rotor hub to a respectively assigned rotor blade, wherein each radial bore is closed off at its radially outer end by the associated rotor blade,
wherein the radial bores and the filler material are formed and coordinated with one another such that, in the event of a loss of a rotor blade, filler material escapes from the thus exposed radial bore assigned to the lost rotor blade, wherein the mass piece moves from its position on the axis of rotation in the direction of the lost rotor blade.

2. The rotor according to claim 1, wherein the imbalance correction device forms tracks for the mass piece, which tracks extend in the volume radially outward from the axis of rotation to the hub bottom side and adjoin at least one radial bore.

3. The rotor according to claim 2, wherein the tracks are defined by radially running structures which are spaced apart in a circumferential direction.

4. The rotor according to claim 3, wherein the radially running structures extend from the hub bottom side in the direction of the axis of rotation.

5. The rotor according to claim 2, wherein the tracks have been milled into a base material of the imbalance correction device.

6. The rotor according to claim 1, wherein the imbalance correction device has valve flaps which divide the volume into regions, wherein the valve flaps are each formed so as to prevent filler material of a region from being able to escape from the region in question counter to the radial direction.

7. The rotor according to claim 6, wherein the valve flaps are arranged such that, in the event of loss of a rotor blade, all of the tracks close aside from the track that adjoins the radial bore through which filler material escapes after loss of the rotor blade.

8. The rotor according to claim 6, wherein the valve flaps are each formed by two inner walls which extend substantially in a circumferential direction and, in so doing, are arranged at an angle with respect to one another.

9. the rotor according to claim 6, wherein the imbalance correction device has multiple concentric arrangements of inner walls.

10. The rotor according to claim 1, wherein the mass piece is of cylindrical form or formed as a ball.

11. The rotor according to claim 1, wherein the mass piece is formed from a metal.

12. The rotor according to claim 1, wherein the filler material is formed by a flowable powder or bulk material.

13. The rotor according to claim 1, wherein the filler material is formed by glass beads with a mean grain size in the range between 0.01 mm and 0.1 mm, in particular in the range between 0.04 mm and 0.06 mm.

14. The rotor according to claim 1, wherein the filler material is a liquid or a gas.

15. The rotor according to claim 1, wherein the radial bores are formed such that they end in the respective rotor blade at a radial distance from the hub top side.

16. The rotor according to claim 1, wherein a multiplicity of imbalance correction devices, which are arranged one behind the other in an axial direction in the rotor, with respectively assigned radial bores, wherein the radial bores of the individual imbalance correction devices extend into the rotor blades in a radial direction to different extents.

17. The rotor according to claim 1, wherein the rotor is a fan, and the rotor blades are fan blades.

18. The rotor according to claim 1, wherein the rotor blades and the rotor hub are formed as a single piece.

19. A gas turbine engine having a rotor according to claim 1.

20. A gas turbine engine according to claim 19, said gas turbine engine having:
an engine core which comprises a turbine, a compressor and a core shaft connecting the turbine to the compressor and formed as a hollow shaft;
a fan which is positioned upstream of the engine core, wherein the fan comprises a plurality of fan blades and is designed; and
a gearbox that receives an input from the turbine shaft and outputs drive for the fan so as to drive the fan at a lower rotational speed than the turbine shaft.
